(19) United States
(12) Patent Application Publication
(10) Pub. No.: US 2009/0158385 A1
(43) Pub. Date: Jun. 18, 2009

(54) Apparatus and method for automatically generating SELinux security policy based on selt

(75) Inventors: Dong-Wook Kim, Seoul (KR); Gyu-Il Cha, DaeJeon (KR); Young-ho Kim, DaeJeon (KR); Eun-Ji Lim, DaeJeon (KR); Soo-Young Kim, Seoul (KR); Sung-In Jung, DaeJeon (KR); Myung-Joon Kim, DaeJeon (KR); Bong-Nam Noh, Gwangju (KR); Jung-Soon Kim, Gwangju (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); CHONNAM NATIONAL UNIVERSITY, Gwangju (KR)

(21) Appl. No.: 12/076,783

(22) Filed: Mar. 21, 2008

(30) Foreign Application Priority Data
Dec. 17, 2007 (KR) 10-2007-132650

(51) Int. Cl. G06F 21/00

(52) U.S. Cl. 726/1

(57) ABSTRACT

Provided is an apparatus and method for automatically generating a SELinux security policy based on SELT. In the method, process generation is prepared by receiving execution file names of a program destined for policy generation. A system call log, which is traced by generating a process by executing the received execution file of the program, is stored. The traced system call log is purified into data necessary for generation of a security policy. Objects are grouped in consideration of the relationship between the objects based on purified information. A normalized data structure is recorded in an SELT description language format using a security policy file. Duplication and collision between the generated SELT security policy and the previous security policy in a system are detected.

### CROSS-REFERENCE TO RELATED APPLICATIONS

This application claims priority under 35 U.S.C. §119 to Korean Patent Application No. P2007-132650, filed in Korea on Dec. 12, 2007, the disclosure of which is incorporated herein by reference in its entirety.

### BACKGROUND OF THE INVENTION

1. Field of the Invention

The present disclosure relates to an apparatus and method for automatically generating a SELinux (Security Enhanced Linux) security policy based on SELT (SELinux Template), and more particularly, to an apparatus and method for automatically generating a SELT-based SELinux security policy that are adaptive for easily generating a security policy automatically without the need for users to detect resource access information.

2. Description of the Related Art

The development of the Internet not only provides the convenience of the use of information but also involves exposure to malicious attacks. Thus, application layer security technologies such as encryption, firewalls, and intrusion detection systems are developed to protect information of networks or servers for the safe sharing and use of information. However, such application layer security technologies not only have their own weakness but also have difficulty in providing against attacks that are caused by intrusion of insiders, misuse of authority, and hacking of the system. In order to overcome these limitations, extensive research is being conducted on a security operating system for implementing a trusted computing base (TCB). A typical example of such a security operation system may enumerate a SELinux (Security Enhanced Linux).

The SELinux is a security operation system that is developed by the NSA (National Security Agency) by applying a FLASK (Flux Advanced Security Kernel) structure to Linux. The SELinux provides a structure for executing a variety of access control policies such as type enforcement (TE), role-based access control (RBAC), and multi-level security (MLS). Further, the SELinux performs access control for a variety of system resources such as processes, signals, and memories as well as files and device files. Also, through minimum authority allocation, the SELinux minimizes a damaged range and prevents execution of malicious codes. Also, the SELinux provides the flexibility of a security policy by dividing a policy decision from a policy execution module.

However, the SELinux has many types of operations and subdivided object classification and thus has a complex security policy. The SELinux has a complex relationship between rules, which makes it difficult for the user to change the security policy with ease. In order to overcome these limitations, research has been conducted on schemes capable of using the SELinux more easily. Typical examples of the researched scheme include SELT, SEEdit, and Polgen.

The research on the SELinux has been conducted mainly to develop tools which facilitate writing a complex and difficult SELinux security policy. Typical examples of the developed tools include SETools of Tresys Technology, SLAT of MITRE Corporations, and SEEdit 1.X of Hitachi Software. These tools, however, still have difficulty in setting a security policy.

The SELinux enables a finer access control for system resources, but this increases the complexity of a security policy, which makes it very difficult for general users to write a security policy at their purposes.

### SUMMARY

Therefore, an object of the present invention is to provide an apparatus and method for automatically generating a SELT-based SELinux security policy, which detects an operation pattern of a designated application in order to automatically write a security policy of the application, and is adaptive for automatically generating a SELT-based SELinux security policy based on the detected operation pattern.

Another object of the present invention is to provide an apparatus and method for automatically generating a SELT-based SELinux security policy, which detects an operation pattern of a designated application in order to automatically write a security policy of the application, and automatically generates a SELT-based SELinux security policy based on the detected operation pattern, thereby enabling even nonprofessional users to write a security policy.

Another object of the present invention is to provide an apparatus and method for automatically generating a security policy that are adaptive for easily generating a security policy without the need for the user to detect resource access information, thereby increasing the utilization of a security operating system.

Another object of the present invention is to provide an apparatus and method for automatically generating that are adaptive for automatically generating a SELT-based SELinux security policy, thereby increasing the readability and thus enabling the user to perform an additional correction operation with ease.

To achieve these and other advantages and in accordance with the purpose(s) of the present invention as embodied and broadly described herein, a method for automatically generating a SELinux security policy based on SELT in accordance with an aspect of the present invention includes: preparing process generation by receiving execution file names of a program destined for policy generation; storing a system call log traced by generating a process by executing the received execution file of the program; purifying the traced system call log into data necessary for generation of a security policy; grouping objects in consideration of the relationship between the objects based on purified information; recording a normalized data structure in a system in an SELT description language format using a security policy file; and detecting duplication and collision between the generated SELT security policy and the previous security policy in the system.

To achieve these and other advantages and in accordance with the purpose(s) of the present invention, an apparatus for automatically generating a SELinux security policy based on SELT in accordance with another aspect of the present invention includes: a testing module for preparing process generation by receiving execution file names of a program destined for policy generation; a tracing module for storing a system call log traced by generating a process by executing the received execution file of the program after the process generation is prepared by the testing module; a parsing module for purifying the traced system call log into data necessary for generation of a security policy; a normalizing module grouping objects in consideration of the relationship between the objects based on information purified by the parsing module; a recording module recording a normalized data structure in a system in an SELT description language format using a security policy file; and a verifying module configure to detect duplication and collision between the SELT security policy generated by the recording module and the previous security policy in the system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an apparatus for automatically generating a SELinux security policy based on SELT according to an embodiment of the present invention;

FIG. 2 is a flowchart of a method for automatically generating a SELinux security policy based on SELT according to an embodiment of the present invention; and

FIG. 3 illustrates duplication declaration check items performed in a duplication declaration check illustrated in FIG. 2.

### DETAILED DESCRIPTION OF EMBODIMENTS

Hereinafter, specific embodiments will be described in detail with reference to the accompanying drawings.

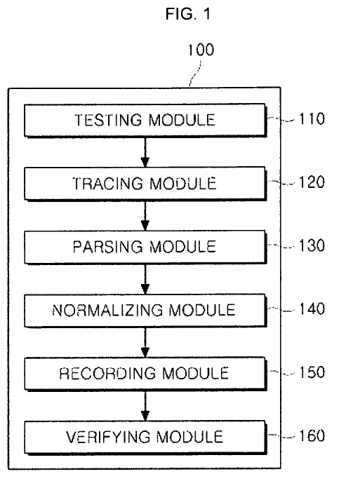

FIG. 1 is a block diagram of an apparatus for automatically generating a SELinux security policy based on SELT according to an embodiment of the present invention.

Referring to FIG. 1, an automatic SELinux security policy generation apparatus 100 includes a testing module 110, a tracing module 120, a parsing module 130, a normalizing module 140, a recording module 150, and a verifying module 160.

The testing module 110 receives a file name of a program, which is destined for policy generation, from a user and determines whether to execute the same.

If the execution is determined by the testing module 110, the tracing module 120 executes the received execution file of the program to generate a process, thereby storing system call log information traced.

The parsing module 130 purifies the data information, which is traced by the tracing module 120, into data necessary for generation of a security policy.

The normalizing module 140 normalizes the data format information, which is purified by the parsing module 130, to thereby solve the problem of the complexity of a system policy.

The recording module 150 converts the data format, which is normalized by the normalizing module 140, into a SELT description language format to record the same using a security policy file based on SELT.

The verifying module 160 checks the vulnerability of a security policy, which is generated by the recording module 150, and reports the check results to the user.

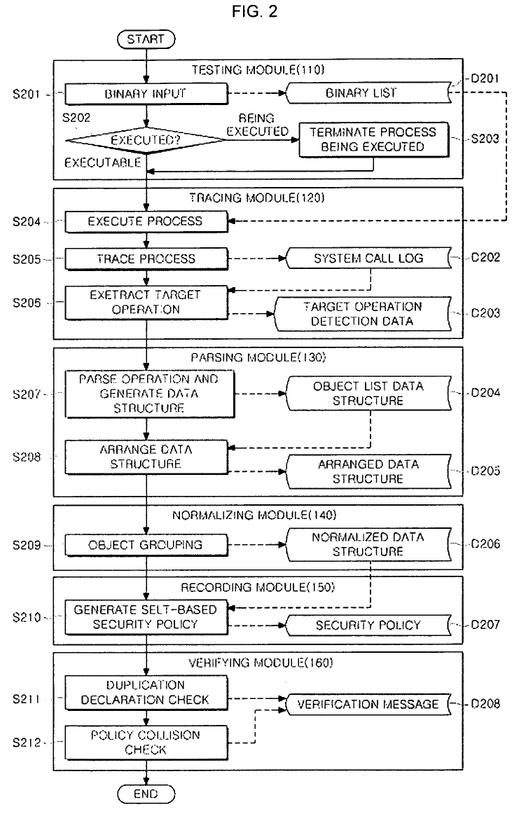

FIG. 2 is a flowchart of a method for automatically generating a SELinux security policy based on SELT according to an embodiment of the present invention, which illustrates a detailed procedure for generating a security policy of an application designated by the user.

Referring to FIG. 2, the testing module 110 receives an executable binary file name of a process, which the user desires to generate, and thereafter checks whether a binary indicated by the received file name is valid to thereby store the binary in a binary list D201 (in step S201). Herein, a plurality of file names may be received so that a plurality of execution files for one service demon can be combined and managed by one policy file.

Upon completion of binary input, the testing module 110 checks whether to execute one by one from the received binary list D201 (in step S202) and, if a binary is already being executed, searches and terminates the pertinent process (in step S203). The reason for the termination of the pertinent process is that it is impossible to generate a normal security policy because an error occurs due to the problem of system resource distribution with respect to the previous process when the already being executed process is re-executed and traced.

If all the binaries in the binary list are executable, the tracing module 120 executes a binary with the aid of a strace being a system call trace tool (hereinafter referred to as “strace”), to generate a process (in step S204). At this time, the tracing module 120 stores log information, which is obtained by tracing all the system calls generated in a driven process, in a system call log D202 (in step S205).

The tracing module 120 extracts a analysis target system call log from the system call log D202 and stores the same in analysis target operation detection data D203 (in step S206). Herein, there are the 317 number of Linux system calls (for Linux kernel 2.6.17), and it is inefficient to analyze information about all the system calls. Accordingly, based on a simplified operation of SELT, only ten system calls of open, unlink, mkdir, create, chdir, execve, mount, rmdir, bind, and socket are stored in the analysis target operation detection data D203.

The parsing module 130 reads one by one the system call logs stored in the analysis target operation detection data D203 to determine the types of the system calls, and performs a parsing operation suitable for the type of each system call to extract an object and operation information (in step S207). In this process, the parsing operation for each system call generates an object list data structure D204 by analyzing information about an object and an operation accessed through trace data information. For network objects, socket/bind system calls are analyzed and stored in the object list data structure D204 for the used protocol and port number. For file objects, open, unlink, execve, creat, mkdir, execve, chdir, mount, and rmdir system calls are analyzed and stored in the object list data structure D204 that stores an object path, an object pattern, the type of an object, and a SELT operation for an object.

After completion of the system call log parsing operation, the parsing module 130 arranges the object list data structure D204 according to the object types to generate an arranged data structure D205 (in step S208). In the data structure arranging step (S208), the arrangement of file objects in the object list data structure D204 is performed based on three criterions of a path depth, a file/directory, and an alphabetical order. The three criterions are high in priority in the order named. First, the lowest priority order is given to a root directory (/) with the shallowest object path. If the path depths are the same, the priority order of the directory is set to be higher than that of the file. If the path depths and the object types are the same, the priority orders are determined in alphabetical order. This arrangement method minimizes an error in policy which may occur later. In the object list data structure D204, a network object is processed by combining the port number and protocol used by the program. If two or more programs are received from the testing module 110, the processing of the network must be performed for each program. This is to process data for the next program after processing of all the trace data for one program, because the values of file descriptors used for a process of analyzing the socket/bind system call trace data may overlap for each program.

Information stored in the arranged data structure D205 must undergo object normalization. The object normalization is a process for redefining objects in the system in consideration for the relationship with the previous security policy, which groups the objects into object sets depending on the relationship therebetween, thereby reducing the complexity of a security policy of the system.

The normalizing module 140 compares data of the arranged data structure with the system security policy to check the possibility of their integration. If the integration is possible, the normalizing module 140 increases a count of an object by ‘1’. On the other hand, if the integration is impossible, the normalizing module 140 generates a normalized data structure D206 by adding an operation access authority for the object (in step S209). The object grouping is performed for normalization of the data structure.

Based on the normalized data structure D206, the recording module 150 writes a security policy file configured in the order of template declaration, subject definition, transition definition, object definition, and authority definition according to the SELT description language format (in step S210).

The verifying module 160 checks a duplication declaration for the contents of a generated security policy (in step S211). Herein, a SELT security policy is not written into one file but is written into a SELT security policy file for each SELT template. Accordingly, the contents of the generated security policy may overlap with the contents of the previous SELT security policy.

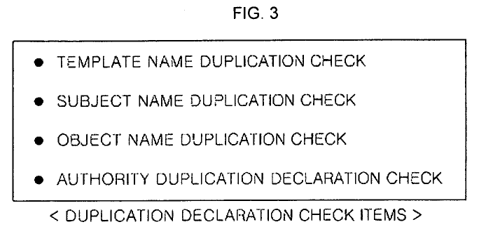

As illustrated in FIG. 3, in the duplication declaration check step (S211), the duplication declaration check performs a duplication declaration check operations such as template name duplication check, subject name duplication check, object name duplication check, and authority duplication declaration check, and reports the results of the duplication declaration check to a verification message D208.

Thereafter, the verifying module 160 performs a policy collision check for checking an authority declaration collision of subjects and objects between the generated security policy and the previous security policy (in step S212). The policy collision check is done to detect the ambiguity of the security policy.

As described above, the present invention detects an operation pattern of a designated application in order to automatically write a security policy of the application, and automatically generates a SELT-based SELinux security policy based on the detected operation pattern, thereby enabling even nonprofessional users to write a security policy.

Also, the present invention automatically generates a security policy with ease without the need for the user to detect resource access information, thereby increasing the utilization of a security operating system.

Also, the present invention automatically generates a SELT-based SELinux security policy, thereby increasing the readability and thus enabling the user to perform an additional correction operation with ease.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A method for automatically generating a SELinux (Security Enhanced Linux) security policy based on SELT (SELinux Template), the method comprising:
preparing process generation by receiving execution file names of a program destined for policy generation;
storing a system call log traced by generating a process by executing the received execution file of the program;
purifying the traced system call log into data necessary for generation of a security policy;
grouping objects in consideration of the relationship between the objects based on purified information;
recording a normalized data structure in a system in an SELT description language format using a security policy file; and
detecting duplication and collision between the generated SELT security policy and the previous security policy in the system.

2. The method of claim 1, wherein the preparing of the process generation comprises:
receiving file names of a program destined for policy generation and storing the file names in a binary list;
checking whether to execute a process based on information of the binary list; and
if the binary is already being executed, searching and terminating the corresponding process.

3. The method of claim 2, wherein the storing of the file names in the binary list comprises checking whether a binary indicated by the received file names of the program is valid, and storing a valid binary in the binary list.

4. The method of claim 2, wherein the checking of whether to execute the process comprises checking whether to execute one by one from the binary list.

5. The method of claim 2, wherein the storing of the traced system call log comprises:
executing the binary in the binary list by a system call trace tool to generate a process;
storing log information, which is obtained by tracing all the system calls generated in the process, in a system call log; and
extracting target system call log information from the system call log and storing the extracted information in target operation detection data.

6. The method of claim 5, wherein the process is generated after all the binaries in the binary list become executable.

7. The method of claim 5, wherein the purifying of the data comprises:
reading one by one the system call log information stored in the target operation detection data to determine the types of system calls;
performing a parsing operation suitable for the type of each system call to extract an object and operation information; and
arranging the extracted object and operation information according to the object types.

8. The method of claim 7, wherein the performing of the parsing operation and the extracting of the operation information comprises generating an object list data structure by analyzing information about an object and an operation accessed through trace data information.

9. The method of claim 8, wherein the arranging of the information according to the object types comprises, after completion of the system call log parsing, arranging the object list data structure according to the object types to generate an arranged data structure.

10. The method of claim 9, wherein the arrangement of file objects in the object list data structure is performed based on three criterions of a path depth, a file/directory, and an alphabetical order.

11. The method of claim 7, wherein the grouping of the objects comprises normalizing the objects by redefining objects in the system in consideration for the relationship with the previous security policy.

12. The method of claim 7, wherein the grouping of the objects comprises comparing data of the arranged data structure with the system security policy to check the possibility of their integration; increasing a count of an object by ‘1’ if the integration is possible; and generating a normalized data structure by adding an operation access authority for the object if the integration is impossible.

13. The method of claim 11, wherein the recording of the normalized data structure in the system comprises writing a SELinux security policy file in a SELT description language format based on the normalized object information.

14. The method of claim 13, wherein the detecting of the duplication and the collision comprises:
checking a duplication between the generated SELT-based security policy and the previous security policy in the system; and
detecting an authority declaration collision of subjects and objects between the generated SELT security policy and the previous security policy.

15. An apparatus for automatically generating a SELinux (Security Enhanced Linux) security policy based on SELT (SELinux Template), the apparatus comprising:
a testing module for preparing process generation by receiving execution file names of a program destined for policy generation;
a tracing module for storing a system call log traced by generating a process by executing the received execution file of the program after the process generation is prepared by the testing module;
a parsing module purifying the traced system call log into data necessary for generation of a security policy;
a normalizing module grouping objects in consideration of the relationship between the objects based on information purified by the parsing module;
a recording module for recording a normalized data structure in a system in an SELT description language format using a security policy file; and
a verifying module for detecting duplication and collision between the SELT security policy generated by the recording module and the previous security policy in the system.

16. The apparatus of claim 15, wherein the testing module receives file names of a program destined for policy generation and stores the file names in a binary list; checks whether to execute a process based on information of the binary list; and searches and terminates the corresponding process if the binary is already being executed.

17. The apparatus of claim 16, wherein the tracing module executes the binary in the binary list by a system call trace tool to generate a process; stores log information, which is obtained by tracing all the system calls generated in the process, in a system call log; and extracts target system call log information from the system call log and stores the extracted information in target operation detection data.

18. The apparatus of claim 17, wherein the parsing module reads one by one the system call log information stored in the target operation detection data to determine the types of system calls; performs a parsing operation suitable for the type of each system call to extract an object and operation information; and arranges the extracted object and operation information according to the object types.

19. The apparatus of claim 18, wherein the normalizing module normalizes the objects by redefining objects in the system in consideration for the relationship with the previous security policy.

20. The apparatus of claim 18, wherein the normalizing module compares data of the arranged data structure with the system security policy to check the possibility of their integration;
increases a count of an object by ‘1’ if the integration is possible; and generates a normalized data structure by adding an operation access authority for the object if the integration is impossible.

21. The apparatus of claim 19, wherein the recording module writes a SELinux security policy file in a SELT description language format based on the normalized object information.

22. The apparatus of claim 21, wherein the verifying module checks a duplication between the generated SELT-based security policy and the previous security policy in the system; and
detects an authority declaration collision of subjects and objects between the generated SELT security policy and the previous security policy.

23. (canceled)

23. (canceled)

24. A method for automatically generating a SELinux (Security Enhanced Linux) security policy based on SELT (SELinux Template), the method comprising:
preparing process generation by receiving execution file names of a program destined for policy generation;
storing a system call log traced by generating a process by executing the received execution file of the program;
purifying the traced system call log into data necessary for generation of a security policy;
grouping objects in consideration of the relationship between the objects based on purified information; and
recording a normalized data structure in a system in an SELT description language format using a security policy file.

25. An apparatus for automatically generating a SELinux (Security Enhanced Linux) security policy based on SELT (SELinux Template), the apparatus comprising:
a testing module for preparing process generation by receiving execution file names of a program destined for policy generation;
a tracing module for storing a system call log traced by generating a process by executing the received execution file of the program after the process generation is prepared by the testing module;
a parsing module purifying the traced system call log into data necessary for generation of a security policy;
a normalizing module grouping objects in consideration of the relationship between the objects based on information purified by the parsing module; and
a recording module for recording a normalized data structure in a system in an SELT description language format using a security policy file.
